(19) United States
(12) Patent Application Publication
(10) Pub. No.: US 2003/0119979 A1
(43) Pub. Date: Jun. 26, 2003

(54) Polyurethane dispersions

(76) Inventors: Larz Zander, Duesseldorf (DE); Rainer Hoefer, Duesseldorf (DE); Ulrich Nagorny, Hilden (DE); Silvia Sauf, Duesseldorf (DE)

Correspondence Address: COGNIS CORPORATION, 2500 RENAISSANCE BLVD., SUITE 200, GULPH MILLS, PA, 19406

(21) Appl. No.: 10/168,199

(22) PCT Filed: Dec. 8, 2000
(86) PCT No.: PCT/EP00/12368

(30) Foreign Application Priority Data
Dec. 17, 1999 (DE) 199 60 952.7

(51) Int. Cl. C08K 3/20

(52) U.S. Cl. 524/591

(57) ABSTRACT

The invention relates to aqueous polyurethane dispersions with an acid number of 5 to 60 mg KOH/g of the polyurethane solid, a hydroxyl group content of 0.25 to 6.5% by weight and 2 to 25% by weight of urethane groups (calculated as —NH—CO—O—) based on the polyurethane solid. The inventive dispersions are characterized in that the polyurethanes are the reaction products of a) 10 to 80% by weight of at least one dimer diol, b) 10 to 80% by weight of at least one dimer diol carboxylic acid and/or dimer diol ether, c) 1 to 10% by weight of at least one acidic component that consists of I) hydroxycarboxylic acids, ii) aminocarboxylic acids, iii) aminosulfonic acids and iv) hydroxysulfonic acids, d) 0 to 20% by weight of a low-molecular component that consists of compounds of the molecular weight range of 60 to 300 and that carry at least two hydroxyl and/or amino groups, e) 0 to 20% by weight of at least one hydrophilic, mono- or polyvalent alcohol of the molecular weight range of 350 to 3,000 that carries ethylene oxide moieties, and f) 5 to 40% by weight of an isocyanate component. The reaction products are at least partially base-neutralized and the percentages indicated add up to 100.

### FIELD OF THE INVENTION

This invention relates to aqueous dispersions of special polyurethanes containing hydroxyl groups and urethane groups.

### PRIOR ART

Polyurethanes (PURs) are a very broad group of polymers differing widely in their composition and in their property profiles. One feature common to all polyurethanes is the principle on which they are synthesized, i.e. they are produced by the diisocyanate polyaddition process. These compounds are all characterized by urethane groups —NH—CO—O— which are formed by polyaddition of hydroxy compounds, generally diols or polyols, onto the —NCO groups of difunctional or polyfunctional isocyanates. In most cases, the urethane group links polyalkylene ether and/or polyester sequences which have molecular weights of about 200 to 6,000. Polyurethanes are commercially available, for example, as foams, thermoplastic granules, solutions, aqueous dispersions and in the form of prepolymers.

The following products, for example, are produced from polyurethanes: highly elastic foams (mattresses, cushions, car seats), rigid foams (insulating materials), rigid and flexible moldings with a compact outer skin (window frames, housings, skis, car fenders, hood and trunk parts, steering wheels, shoe soles), industrial moldings combining high elasticity and rigidity, ski boots, films, blow moldings, car fenders, printing rolls, paints, adhesives, textile coatings, high-gloss paper coatings, leather finishes, elastomer filaments, wool finishes, etc. The number and scope of applications is constantly increasing. Numerous reference books and articles are available on the production, properties, technology and applications of polyurethanes, cf. for example Gerhard W. Becker (Ed.), “Kunststoff-Handbuch—7. Polyurethane” 3rd Edition 1993, pages 455-467 and 508 and 510-512.

EP-B-533 730 (Henkel) describes coating compositions for flexible substrates containing aqueous polyurethane dispersions of which the polyurethanes are produced from a polyol mixture consisting at least predominantly of polycaprolactone diols, an isocyanate mixture with an average NCO functionality of more than 1.5 and functional components capable of forming salts in aqueous solution and, if desired, chain extending agents. However, dimer diol and dimer diol carbonate are not building blocks for the production of the polyurethane.

EP-B-590 480 (BASF) describes polyurethane coating compositions containing an aqueous medium, a special water-dispersible polyurethane resin with a hydroxyl value of at least 5 and an amino resin crosslinking agent. Dimer diol, but not dimer diol carbonate, is used as a building block in the production of the polyurethane resin.

DE-A-42 37 965 (Henkel) describes special polyurethane dispersions and their use as binders in stoving lacquers. Dimer diol, but not dimer diol carbonate, is used as a building block in the production of the polyurethane resin.

DE-A-43 16 245 (Henkel) describes special polyalkylene glycols and their use inter alia for sealants and coating compositions.

DE-A-195 12 310 (Parker-Prädifa) describes thermoplastic polyurethanes and their use for the production of seals. Dimer diol and dimer diol carbonate, but not acid components, such as dimethylolpropionic acid, are used as building blocks for the production of the polyurethanes.

DE-A-195 13 164 (Bayer) describes polycarbonate diols and their use as starting products for polyurethane plastics.

DE-A-195 25 406 (Henkel) describes the production and use of oligocarbonates of dimer diol.

EP-B-669 352 (Bayer) describes special aqueous polyester polyurethane dispersions and their use in coating compositions. The dispersions contain polyurethanes of the type where at least one linear polyesterpolyol has to be used as a building block in the production process. According to page 4, lines 3 et seq of EP-B-669 352, the polyester polyols are produced by polycondensation of at least two special components, adipic acid being a preferred compound for one of these two components and dimer diol being a preferred compound for the second component.

### DESCRIPTION OF THE INVENTION

The problem addressed by the present invention was to provide water-based binders which would be suitable for highly elastic paints, coatings and sealing compounds, would have favorable film “mechanics” and adhesion, would be distinguished by high solvent resistance and, in addition, would contain few—if any—volatile organic compounds in order to satisfy stringent environmental compatibility requirements.

In a first embodiment, therefore, the present invention relates to aqueous dispersions of polyurethanes with an acid value of 5 to 60 mg KOH/g polyurethane solids, a hydroxyl group content of 0.25 to 6.5% by weight and a urethane group content (expressed as —NH—CO—O—) of 2 to 25% by weight, based on polyurethane solids, characterized in that the polyurethanes are reaction products—optionally at least partly neutralized with bases—of

a) 10 to 80% by weight of at least one dimer diol,

b) 10 to 80% by weight of at least one dimer diol carbonate and/or dimer diol ether,

c) 1 to 10% by weight of at least one acid component consisting of i) hydroxycarboxylic acids, ii) aminocarboxylic acids, iii) aminosulfonic acid and iv) hydroxysulfonic acids,

d) 0 to 20% by weight of a low molecular weight component consisting of compounds containing at least two hydroxyl and/or amino groups with a molecular weight in the range from 60 to 300,

e) 0 to 20% by weight of at least one hydrophilic mono- or polyhydric alcohol containing ethylene oxide units with a molecular weight in the range from 350 to 3,000,

f) 5 to 40% by weight of an isocyanate component,

the percentages mentioned adding up to 100.

It is specifically pointed out that the polyester polyols described in the above-cited EP-B-669 352 (cf. page 2, line 34 and page 4, lines 3 to 22) are excluded as building blocks for the polyurethanes according to the present invention.

The present invention also relates to the use of the above-mentioned dispersions for the production of water-containing coating compositions based on binders and crosslinker resins dispersed in water. The crosslinker resins are selected from the group consisting of amino resins, optionally hydrophilicized blocked isocyanates and optionally hydrophilicized isocyanates containing free isocyanate groups.

The present invention also relates to water-containing coating compositions which contain as binder a combination of

A) a polyol component with

B) a crosslinker resin selected from the group consisting of melamine resins, optionally hydrophilicized blocked isocyanates and optionally hydrophilicized isocyanates containing free isocyanate groups,

25 to 100% by weight of component A) consisting of a hydroxyl-group-containing polyurethane of the type present in dispersed form in accordance with the invention and 0 to 75% by weight of other binders different from these polyurethanes. If desired, the coating composition may additionally contain the usual auxiliaries and additives.

The polyurethane dispersions according to the invention generally have solids contents of 15 to 68 and preferably 33 to 60% by weight and viscosities of 10 to 20,000 and preferably 50 to 5,000 mPas, as measured at 23° C. with a rotational viscosimeter. Their pH is adjusted to a value of 5 to 10 and preferably 6 to 8 and is determined to DIN 53 785 after dilution with distilled water to a solids content of 10% by weight. In the context of the invention, the term “dispersion” is intended to encompass both genuine aqueous dispersions and aqueous solutions. The question of whether the dispersion is a genuine dispersion or a solution is dependent in particular upon the content of salt-like groups and upon the molecular weight of the polymers.

The polyurethanes present as disperse phase in the dispersions have a content of urethane groups (—NH—CO—O—), based on solids, of 2 to 25 and preferably 4 to 19% by weight, an acid value of 5 to 60 mg KOH/g and preferably 8 to 40 mg KOH/g, the acid value being based both on free acid groups and on base-neutralized acid groups of the solid, and a hydroxyl group content of 0.25 to 6.5 and preferably 0.5 to 3.5% by weight. The dilutability of the polyurethanes with water is largely attributable to their content of the anionic groups mentioned.

The dispersions are produced by reaction of

10 to 80 and preferably 20 to 70% by weight of starting component a),

10 to 80 and preferably 10 to 60% by weight of starting component b),

1 to 10 and preferably 2 to 7% by weight of starting component c),

0 to 20 and preferably 0.5 to 20% by weight of starting component d),

0 to 20 and preferably 0 to 10% by weight of starting component e)

with 5 to 40 and preferably 7 to 30% by weight of starting component f),

the percentages mentioned for a) to f) adding up to 100% by weight, in 40 to 100% and preferably in 85 to 100% organic solution (100%=solvent-free), components a) to e) being introduced first, optionally with solvent, and being reacted with component f) in the presence of 0 to 2.5 and preferably 0.01 to 0.5% by weight of suitable catalysts at 40 to 160° C. so that hardly any free NCO groups can be detected after the reaction.

This reaction is generally carried out with an equivalent ratio of isocyanate-reactive groups to isocyanate groups of 1.1:1 to 2.5:1 and preferably 1.2:1 to 1.5:1, so that reaction products with the hydroxyl group content mentioned above are ultimately obtained. Any carboxyl groups intended for conversion into anionic groups present in the reaction mixture are not regarded as “isocyanate-reactive”.

On completion of the reaction mentioned, the reaction mixture is dispersed or dissolved in water, 25 to 100% and preferably 45 to 100% of any acid groups introduced into the reaction mixture being converted into salt groups during the reaction or before or during the dispersion step by addition of a neutralizing agent. The incorporation of anionic groups in this way is of course unnecessary where salts, particularly alkali metal salts, of suitable amino- or hydroxycarboxylic or -sulfonic acids are used as synthesis component c).

In a preferred embodiment, the dispersions are produced by reacting a mixture of

10 to 80 and preferably 20 to 70% by weight of starting component a),

10 to 80 and preferably 10 to 60% by weight of starting component b),

1 to 10 and preferably 2 to 7% by weight of starting component c),

with 5 to 40 and preferably 7 to 30% by weight of starting component f),

in a first stage in which an equivalent NCO:OH ratio of 1.05:1 to 2:1 and more particularly 1.2:1 is adjusted and reacting the “intermediate compound” obtained with

0.5 to 20% by weight of starting component d)

in a second stage. Once again, the percentages mentioned for a), b), c), d) and f) add up to 100% by weight and hardly any free NCO groups can be detected at the end of the second stage. So far as the use of solvents and catalysts and dispersion in water are concerned, the foregoing observations apply.

Starting component a) is selected from dimer diols. Dimerdiols are well-known commercially available compounds which are obtained, for example, by reduction of dimer fatty acid esters. The dimer fatty acids on which these dimer fatty acid esters are based are carboxylic acids which may be obtained by oligomerization of unsaturated carboxylic acids, generally fatty acids, such as oleic acid, linoleic acid, erucic acid and the like. The oligomerization is normally carried out at elevated temperature in the presence of a catalyst, for example of clay. The substances obtained—dimer fatty acids of technical quality—are mixtures in which the dimerization products predominate. However, small amounts of higher oligomers, more particularly the trimer fatty acids, are also present. Dimer fatty acids are commercially available products and are marketed in various compositions and qualities. Abundant literature is available on the subject of dimer fatty acids, cf. for example the following articles: Fette & Öle 26 (1994), pages 47-51; Speciality Chemicals 1984 (May Number), pages 17, 18, 22-24. Dimerdiols are well-known among experts, cf. for example a more recent article in which inter alia the production, structure and chemistry of the dimerdiols are discussed: Fat Sci. Technol. 95 (1993), No. 3, pages 91-94. According to the invention, preferred dimerdiols are those which have a dimer content of at least 70% and more particularly 90% and in which the number of carbon atoms per dimer molecule is mainly in the range from 36 to 44.

Starting component b) is selected from dimer diol carbonates and/or dimer diol ethers. Among the dimer diol carbonates—often also referred to as polycarbonate diols—difunctional polyols with a molecular weight in the range from 400 to 6,000 are preferred. Dimer diol ethers are special polyether polyols which contain dimer diol as a structural element. Dimer diol ethers are obtainable by alkoxylation of dimer diols. These alkoxylated diols are normally produced as follows: in a first step, the required dimer diol is contacted with ethylene oxide and/or propylene oxide and the resulting mixture is reacted at temperatures of 20 to 200° C. in the presence of an alkaline catalyst. Addition products of ethylene oxide (EO) and/or propylene oxide (PO) onto the dimer diol used are obtained in this way. Accordingly, the addition products are EO adducts or PO adducts or EO/PO adducts with the particular dimer diol. In the case of the EO/PO adducts, the addition of EO and PO may be carried out statistically or in blocks.

A molecular weight in the range from 350 to 3,500 is preferred for the dimer diol ethers.

Starting component c) is at least one hydroxycarboxylic acid and/or aminocarboxylic acid and/or aminosulfonic acid and/or hydroxysulfonic acid of the type mentioned, for example, in U.S. Pat. No. 3,479,310. Preferred components c) include 2,2-bis-(hydroxymethyl)-alkanemonocarboxylic acids containing a total of 5 to 8 carbon atoms. 2,2-Dimethylol propionic acid and 2,2-dimethylol butyric acid are most particularly preferred. If desired, the components c) may also be used in the form of their alkali metal salts providing they are sufficiently compatible with the other synthesis components of the polyurethanes.

Starting component d) is selected from compounds containing at least two hydroxyl and/or amino groups with a molecular weight in the range from 60 to 300. Suitable compounds such as these are, for example, ethylene glycol, propylene glycol, neopentyl glycol, butanediol, hexanediol, cyclohexane dimethanol, diethylene glycol, dipropylene glycol, trimethylol propane (TMP), 1,4-cyclohexanediol, glycerol, pentaerythritol, aminoethanol, aminoisopropanol and mixtures of these and other corresponding compounds.

Starting component e) is selected from nonionic hydrophilic polyethylene glycols containing one or two hydroxyl groups. These polyethylene glycols are preferably mono- or dihydric polyether alcohols with a molecular weight in the range from 350 to 2,000 which are obtainable in known manner by alkoxylation of mono- or dihydric alcohols as starter molecules, ethylene oxide or mixtures of ethylene oxide and propylene oxide preferably being used as alkylene oxides.

Starting component f) is an isocyanate. The choice of the isocyanate is not subject to any particular limitations. In principle, therefore, any isocyanates known to the relevant expert may be used.

Diisocyanates, oligo- or polyisocyanates and mixtures of these compounds are preferably used. Polyisocyanates in the context of the invention include, for example, adducts of diisocyanates with trimethylolpropane, biurets, uretdiones (cyclodimerized isocyanates), isocyanurates (cyclotrimerized isocyanates), allophanates, carbodiimide-based isocyanates and the like (with regard to expert knowledge on the subject of di- and polyisocyanates, reference is made purely by way of example to: Ullmanns Encyklopädie der technischen Chemie, Vol. 19, 4th Edition, Weinheim 1980, pages 302-304 and to Kirk-Othmer, Encyclopedia of Chemical Technology, 4th Edition, New York 1995, Volume 14, pages 902-934 and finally to Gerhard W. Becker [Ed.], Kunststoff-Handbuch, Vol. 7: “Polyurethane” [edited by Günter Oertel], 3rd Edition, Munich 1993, pages 11-21, 76-103). Particular reference is made to commercially available polyisocyanates, for example polymer-MDI and the like which are commercially available in various degrees of polymerization.

Preferred diisocyanates are compounds with the general structure O═C═N—X—N═C═O where X is an aliphatic, alicyclic or aromatic radical, preferably an aliphatic or alicyclic radical containing 4 to 18 carbon atoms.

Suitable diisocyanates are, for example, 1,5-naphthylene diisocyanate, 4,4′-diphenylmethane diisocyanate (═methylene diphenylene diisocyanate, MDI), hydrogenated MDI (H₁₂MDI, a cycloaliphatic compound), xylylene diisocyanate (XDI), tetramethyl xylylene diisocyanate (TMXDI), 4,4′-diphenyldimethylmethane diisocyanate, di- and tetraalkyl diphenylmethane diisocyanate, 4,4′-dibenzyl diisocyanate, 1,3-phenylene diisocyanate, 1,4-phenylene diisocyanate, the isomers of toluene diisocyanate (TDI, more particularly the technical isomer mixture of essentially 2,4- and 2,6-toluene diisocyanate), 1-methyl-2,4-diisocyanatocyclohexane, 1,6-diisocyanato-2,2,4-trimethylhexane, 1,6-diisocyanato-2,4,4-trimethylhexane, 1-isocyanatomethyl-3-isocyanato-1,5,5-trimethyl cyclohexane (isophorone diisocyanate═IPDI), chlorinated and brominated diisocyanates, phosphorus-containing diisocyanates, 4,4′-diisocycnatophenyl perfluoroethane, tetramethoxybutane-1,4-diisocyanate, butane-1,4-diisocyanate, hexamethylene diisocyanate (HDI), dicyclohexylmethane diisocyanate, cyclohexane-1,4-diisocyanate, ethylene diisocyanate, phthalic acid-bis-isocyanatoethyl ester, diisocyanates containing reactive halogen atoms, such as 1-chloromethylphenyl-2,4-diisocyanate, 1 -bromomethylphenyl-2,6-diisocyanate, 3,3-bis-chloromethylether-4,4′-diphenyl diisocyanate. Sulfur-containing polyisocyanates are obtained, for example, by reaction of 2 mol hexamethylene diisocyanate with 1 mol thiodiglycol or dihydroxydihexyl sulfide. Other important diisocyanates are trimethyl hexamethylene diisocyanate, 1,4-diisocyanatobutane, 1,12-diisocyanatododecane and dimer fatty acid diisocyanate (“Sovermol DD1 1410”, a product of Cognis Deutschland GmbH—formerly Henkel KGaA). Particularly suitable diisocyanates are tetramethylene, hexamethylene, undecane, dodecamethylene, 2,2,4-trimethylhexane, 1,3-cyclohexane, 1,4-cyclohexane, 1,3- or 1,4-tetramethyl xylene, isophorone, 4,4-dicyclohexyl methane and lysine ester diisocyanate.

One embodiment of the present invention is characterized by the use of linear aliphatic diisocyanates with a molecular weight in the range from 168 to 1,000, at least 50% by weight of the isocyanate component representing diisocyanates with a molecular weight in the range from 168 to 300.

Another embodiment of the invention is characterized by the use of isocyanates of relatively high functionality, i.e. isocyanates with an average NCO functionality of at least 2.0. These include in particular all commercially available polyisocyanates (for example polymer-MDI and the like and the polyisocyanates of formula 1 to 7 disclosed in EP-A-438 836) which have a functionality above 2.0. The expert speaks in terms of an average NCO functionality because the corresponding isocyanates of relatively high functionality do not necessarily have to be present in the form of chemically uniform “individuals”, such as cyclotrimerized isocyanates for example, but instead are often mixtures of different chemical individuals each with defined NCO functionalities, particularly in the case of commercially available technical products.

If desired, the production of the polyurethanes to be used in accordance with the invention is carried out in a solvent. Suitable solvents are, for example, N-methyl pyrrolidone, methoxyhexanone, diethylene glycol dimethyl ether, methyl ethyl ketone, methyl isobutyl ketone, acetone, xylene, toluene, butyl acetate, methoxypropyl acetate or mixtures of these and other solvents. Any organic solvents used may be completely or partly removed before, during or after the dispersion step. The techniques required for this purpose are known and include, for example, distillation, azeotropic distillation and the passage of an inert gas stream through the reaction mixture.

If desired, the urethanization reaction, i.e. the reaction of components a) to f), is carried out in the presence of suitable catalysts. Suitable catalysts for the urethanization reaction, i.e. the reaction of components a) to f), are, for example, triethylamine, tin(II) octoate, dibutyl tin oxide, dibutyl tin dilaurate and other typical catalysts.

Suitable bases for neutralizing the acid groups initially incorporated are, for example, ammonia, N-methyl morpholine, triethylamine, dimethyl ethanolamine, methyl diethanolamine, morpholine, dimethyl isopropanolamine, 2-amino-2-methyl-1-propanol or mixtures of these and other neutralizing agents. Other suitable but less preferred neutralizing agents are sodium hydroxide, lithium hydroxide and potassium hydroxide. Preferred neutralizing agents are ammonia, dimethyl ethanolamine, methyl diethanolamine and dimethyl isopropanolamine.

To carry out the dispersion step, the water/neutralizing agent mixture may be added to the resin, the resin may be added to the water/neutralizing agent mixture or the resin/neutralizing agent mixture may be added to the water. “Resin” in this context means either the polyurethane produced in the absence of solvents or its solution in one of the auxiliary solvents mentioned by way of example. The dispersion step is generally carried out at a temperature in the range from 20 to 100° C. and preferably at a temperature in the range from 40 to 100° C. If desired, the dispersibility of the polyurethanes in water may be improved by the use of external emulsifiers during the dispersion step.

The polyurethane dispersions according to the invention generally have an organic solvent content below 10% by weight, preferably below 6% by weight and more particularly below 4% by weight.

Other organic solvents, more particularly alcohols such as, for example, ethanol, n-butanol, n-octanol, butyl diglycol, ethyl diglycol, methyl diglycol or methoxypropanol, may be added to the dispersions according to the invention after their production in order to obtain certain properties.

The dispersions according to the invention are water-containing binder components for coating compositions based on polyhydroxy compounds and crosslinker resins dispersed in water. The dispersions according to the invention may be used either as sole binders or in the form of mixtures with aqueous dispersions of other binders. Accordingly, 25 to 100% by weight—based on solids—of the polyol component of the coating compositions according to the invention consist of polyurethanes of the type according to the invention and 0 to 75% by weight of other binders dispersible or soluble in water. Other binders in this context are understood in particular to be water-dispersible, optionally hydroxyl-group-containing polyester resins, polyacrylate resins or polyurethane resins known per se which differ in their chemical composition from the polyurethanes according to the invention. The polyurethane resins present, for example, in the PUR dispersions according to DE-A-26 51 506 are preferred. These polyurethane resins preferably do not contain any hydroxyl groups, are linear in structure and have a molecular weight Mn (number average)—calculable from the stoichiometry of the starting materials used for their production—of at least 15,000. They are anionically and/or nonionically-hydrophilically modified. Dispersions containing—based on solids—25 to 80% by weight of polyurethanes of the type according to the invention and 75 to 20% by weight of the polyurethane resins according to DE-A-26 51 506 are preferred as component A).

Suitable crosslinker resins B) are amino resins, optionally hyophilicized polyisocyanates containing blocked isocyanate groups and optionally hydrophilicized polyisocyanates containing free isocyanate groups.

Suitable amino resins are, for example, water-dilutable or water-dispersible melamine- or urea-formaldehyde condensates. However, the melamine resins may also be completely or partly replaced by other crosslinking aminoplastics.

Other suitable crosslinker resins are blocked polyisocyanates, for example based on isophorone diisocyanate, hexamethylene diisocyanates, 1,4-diisocyanatocyclohexane, dicyclohexylmethane diisocyanate, 1,3-diisocyanatobenzene, 1,4-diisocyanatobenzene, 2,4-diisocyanato-1-methylbenzene, 1,3-diisocanato-2-methylbenzene, 1,3-bis-isocyanatomethylbenzene, 2,4-bis-isocyanatomethyl-1,5-dimethylbenzene, bis-(4-isocyanatophenyl)-propane, tris-(4-isocyanatophenyl)-methane, trimethyl-1,6-diisocyanatohexane or blocked “paint-grade polyisocyanates”, such as biuret polyisocyanates based on 1,6-diisocyanatohexane, isocyanurate polyisocyanates based on 1,6-diisocyanatohexane or paint-grade urethane polyisocyanates based on 2,4- and/or 2,6-diisocyanatotoluene or isophorone diisocyanate on the one hand and low molecular weight polyhydroxyl compounds, such as trimethylolpropane, the isomeric propanediols or butanediols or mixtures of such polyhydroxyl compounds on the other hand—all with blocked isocyanate groups.

Other suitable crosslinker resins are, for example, blocked polyisocyanates hydrophilicized by salt groups or polyether structures.

Suitable blocking agents for these polyisocyanates are, for example, monohydric alcohols, such as methanol, ethanol, butanol, hexanol, benzyl alcohol, oximes, such as methyl ethyl ketoxime, lactams, such as ε-caprolactam, phenols or CH-acid compounds, such as diethyl malonate for example.

Suitable polyisocyanate crosslinkers B) containing free isocyanate groups are, for example, organic polyisocyanates containing aliphatically, cycloaliphatically, araliphatically and/or aromatically bound free isocyanate groups which are liquid at room temperature. Polyisocyanate crosslinkers B) such as these generally have a viscosity at 23° C. of 50 to 10,000 and preferably in the range from 50 to 1,500 mPas.

If necessary, the polyisocyanates may be used in admixture with small quantities of inert solvents to reduce their viscosity to a value within the ranges mentioned.

“Paint grade polyisocyanates” based on hexamethylene diisocyanate or on 1-isocyanato-3,3,5-trimethyl-5-isocyanatomethyl cyclohexane and/or dicyclohexylmethane diisocyanate, for example, are particularly suitable. “Paint grade polyisocyanates” based on these diisocyanates are understood to be the biuret-, urethane-, allophanate-, uretdione- and/or isocyanurate-group-containing derivatives of these diisocyanates known per se which, after their production, have been freed from excess starting diisocyanate to a residual content of less than 0.5% by weight in known manner, preferably by distillation. Preferred aliphatic polyisocyanates to be used in accordance with the invention include biuret polyisocyanates based on hexamethylene diisocyanate which satisfy the above-mentioned criteria and which consist of mixtures of N,N′,N″-tris-(6-isocyanatohexyl)-biuret with small quantities of its higher homologs and cyclic trimers of hexamethylene diisocyanate which satisfy the above-mentioned criteria and which consist essentially of N,N′,N″-tris-(6-isocyanatohexyl)-isocyanurate in admixture with small quantities of its higher homologs.

According to the invention, other suitable but less preferred aromatic polyisocyanates are, in particular, “paint grade polyisocyanates” based on 2,4-diisocyanatotoluene or technical mixtures thereof with 2,6-diisocyanatotoluene or on 4,4′-diisocyanatodiphenylmethane or mixtures thereof with its isomers and/or higher homologs. Other suitable polyisocyanate crosslinkers are those which have been hydrophilicized by the incorporation of polyether and/or salt groups.

Preferred crosslinker resins are the above-described polyisocyanate crosslinkers containing free isocyanate groups, more particularly corresponding hydrophilicized crosslinkers. In a particularly preferred embodiment, the polyisocyanate component B) consists of polyisocyanates or polyisocyanate mixtures containing only aliphatically and/or cycloaliphatically bound isocyanate groups with an (average) NCO functionality of 2.2 to 5.0 and a viscosity at 23° C. of 50 to 1,500 mPas.

The coating compositions according to the invention generally contain—based on solids—50 to 95% by weight and preferably 65 to 90% by weight of hydroxyl-group-containing component A) in combination with 5 to 50% by weight and preferably 10 to 35% by weight of crosslinker B). The solids content of the coating compositions is generally in the range from 35 to 70% by weight.

The coating compositions according to the invention may of course contain the auxiliaries and additives known per se in paint technology. Such auxiliaries and additives include, for example, defoaming agents, thickeners, flow controllers, pigments, flatting agents, dispersion aids for dispersing pigments and the like.

The coating compositions according to the invention which contain melamine resins or blocked polyisocyanates as crosslinker resins or coating compositions or sealing compounds based on such binder combinations represent heat-crosslinkable one-component systems which can be stored at room temperature. Corresponding systems which contain polyisocyanates with free isocyanate groups as crosslinkers represent two-component systems which are obtained by mixing the individual components and which have only a limited pot life at room temperature.

Preferred applications for the polyurethane dispersions according to the invention include their use as a binder component in elastic paints, coating and sealing compounds, for example for coating plastics and painting the interior of automobiles. However, the polyurethane dispersions according to the invention are also suitable as a binder component for water-based paints for plastics, films, metals or wood and as a binder component for coating mineral substrates.

### EXAMPLES

### 1. Abbreviations

| | | |
|---|---|---|
| OHV | = | hydroxyl value (OH value) as determined to DIN 53240 |
| AV | = | acid value as determined to DIN 53402 |
| MEK | = | methyl ethyl ketone (solvent) |

### 2. Substances Used

Sovermol 908: dimerdiol (a product of Cognis Deutschland GmbH)

Sovermol 910: dimer diol polyether (a product of Cognis Deutschland GmbH)

Sovermol 913: dimer diol polycarbonate (a product of Cognis Deutschland GmbH)

Quadrol L: tetrakis-(2-hydroxypropyl)-ethylenediamine (a product of Cognis Deutschland GmbH)

Polyester 1 (PE1): In a three-necked flask equipped with a stirrer, internal thermometer and water separator, 505 g (0.9 mol) of Sovermol 908 (OHV=200) and 87.7 g (0.6 mol) of adipic acid were slowly heated to 160° C. and were kept at that temperature until no more water was separated. The resulting polyester (PE1) had an OHV of 66 and an AV of 2.3.

Polyester 2 (PE2): In a three-necked flask equipped with a stirrer, internal thermometer and water separator, 561.2 g (1 mol) of Sovermol 908 (OHV=200) and 73.1 g (0.5 mol) of adipic acid were slowly heated to 160° C. while 100 ppm of trifluoromethanesulfonic acid was added and were kept at that temperature until no more water was separated. After neutralization with Quadrol L, the resulting polyester (PE2) had an OHV of 77 and an AV of 0.2.

Basonat 8878: commercially available isocyanate (BASF)

Cymel 327: formaldehyde-melamine resin (a product of Cytec).

### 3. Production Examples

### Example 1 (B1)

195 g of Sovermol 908 (OHV 205), 407.3 g of Sovermol 913 (OHV 55), 35.2 g of dimethylolpropionic acid and 40.0 g of N-methyl pyrrolidone were introduced into a three-necked flask equipped with a stirrer, internal thermometer, dropping funnel and reflux condenser and dissolved with stirring at 75° C. in 200 g of methyl ethyl ketone. 218.6 g of isophorone diisocyanate were then added dropwise and the reaction mixture was heated to 90° C. After an NCO content of 1.62% by weight had been reached, 44 g of trimethylol propane were added and the whole was stirred until the NCO content had fallen to 0.09% by weight. 15.5 g of dimethyl ethanolamine were then added for neutralization. 200 g of the product were taken up in MEK and, after the addition of 155 ml of hot water, the solvent was removed. The resulting milky white aqueous dispersion had a solids content of 51%.

### Example 2 (B2)

814.5 g (0.8 mol OH) of Sovermol 913 (OHV 55), 27 g (0.2 mol) of dimethylol propionic acid and 90.8 g of N-methyl pyrrolidone were introduced into a three-necked flask equipped with a stirrer, internal thermometer, dropping funnel and reflux condenser and melted with stirring at 75° C. 155.4 g (0.7 mol) of isophorone diisocyanate were then added dropwise and the reaction mixture was heated to 90° C. After an NCO content of 1.62% by weight had been reached, 29.5 g (0.22 mol) of trimethylol propane were added and the whole was stirred at 100° C. until the NCO content had fallen to 0.09% by weight. 17.9 g of dimethyl ethanolamine were then added for neutralization. 200 g of the product were taken up in MEK and, after the addition of 183 ml of hot water, the solvent was removed. The resulting milky white aqueous dispersion had a solids content of 50%.

### Example 3 (B3)

344 g of Sovermol 910 (OHV 57), 17 g of dimethylol propionic acid and 45.4 g of N-methyl pyrrolidone were introduced into a three-necked flask equipped with a stirrer, internal thermometer, dropping funnel and reflux condenser and dissolved with stirring at 75° C. in 81 g of MEK. 77.7 g of isophorone diisocyanate were then added dropwise and the reaction mixture was heated to 90° C. After an NCO content of 1.62% by weight had been reached, 14 g of trimethylol propane were added and the whole was stirred at 100° C. until the NCO content had fallen to 0.09% by weight. 11.2 g of dimethyl ethanolamine were then added for neutralization. 210 g of the product were taken up in MEK and, after the addition of 155 ml of hot water, the solvent was removed. The resulting milky white aqueous dispersion had a solids content of 48%.

### Example 4 (B4)

195 g of Sovermol 908 (OHV 205), 393.0 g of Sovermol 910 (OHV 57), 35.2 g of dimethylolpropionic acid and 40.0 g of N-methyl pyrrolidone were introduced into a three-necked flask equipped with a stirrer, internal thermometer, dropping funnel and reflux condenser and dissolved with stirring in ca. 200 g of methyl ethyl ketone. 218.6 g of isophorone diisocyanate were then added dropwise, the reaction mixture increasing in temperature. After an NCO content of 1.62% by weight had been reached, 44 g of trimethylol propane were added and the whole was stirred until the NCO content had fallen to 0.09% by weight. 15.5 g of dimethyl ethanolamine were then added for neutralization. 190 g of the product were taken up in MEK and, after the addition of 155 ml of hot water, the solvent was removed. The resulting milky white aqueous dispersion had a solids content of 52%.

### Comparison Example 1 (C1)

136 g of polyester 1 (PE1), 55 g of Sovermol 908 (OHV 200), 204 g of Sovermol 913 (OHV 55), 17.6 g of dimethylol propionic acid and 22.4 g of N-methyl pyrrolidone were introduced into a three-necked flask equipped with a stirrer, internal thermometer, dropping funnel and reflux condenser and dissolved with stirring at 75° C. in 125 g of methyl ethyl ketone. 109.3 g of isophorone diisocyanate were then added dropwise and the reaction mixture was heated to 90° C. After an NCO content of 1.29% by weight had been reached, 22 g of trimethylol propane were added and the whole was stirred until the NCO content had fallen to 0.09% by weight. 7.8 g of dimethyl ethanolamine were then added for neutralization. 170 g of the product were taken up in MEK and, after the addition of 160 ml of hot water, the solvent was removed. The resulting milky white aqueous dispersion had a solids content of 50%.

### Comparison Example 2 (C2)

120 g of polyester 2 (PE2), 55 g of Sovermol 908 (OHV 200), 204 g of Sovermol 913 (OHV 55), 17.6 g of dimethylol propionic acid and 22.4 g of N-methyl pyrrolidone were introduced into a three-necked flask equipped with a stirrer, internal thermometer, dropping funnel and reflux condenser and dissolved with stirring at 75° C. in 130 g of methyl ethyl ketone. 109.3 g of isophorone diisocyanate were then added dropwise and the reaction mixture was heated to 90° C. After an NCO content of 1.29% by weight had been reached, 22 g of trimethylol propane were added and the whole was stirred until the NCO content had fallen to 0.09% by weight. 7.8 g of dimethyl ethanolamine were then added for neutralization. 190 g of the product were taken up in MEK and, after the addition of 175 ml of hot water, the solvent was removed. The resulting milky white aqueous dispersion had a solids content of 50%.

### 4. Performance Tests

Film Formation

The polyurethane dispersions of Example 1 according to the invention and Comparison Example 1 were adjusted to a solids content of 40% by weight by dilution with water. A commercially available isocyanate suitable for aqueous systems, Basonat 8878, was then added to and intensively mixed with the dispersions. The isocyanate was added in a quantity corresponding to an NCO:OH ratio of 1:1. The final mixture was applied with a split knife to a flat substrate (a plate of glass) and, after drying for 7 days at a temperature of 23° C., the film was tested for hardness (König pendulum hardness, DIN 53 157). It was also tested for resistance to alcohol (ethanol, to DIN 68861). The results are set out in Table 1 (columns 2 and 3).

Stoving Paints

In addition, stoving paints were produced as follows from the polyurethane dispersions of Example 1 according to the invention and Comparison Example 1:

The polyurethane dispersions of Example 1 according to the invention and Comparison Example 1 were adjusted to a solids content of 40% by weight by dilution with water. A commercially available melamine-formaldehyde resin suitable for water-based systems, Cymel 327, was then added to and intensively mixed with the dispersions. A ratio by weight of polyurethane dispersion to amine-formaldehyde resin of 7:3 was adjusted. The final mixture was applied with a split knife to a flat substrate (a plate of glass) and then dried for 20 minutes at 120° C. The film obtained was tested for hardness (König pendulum hardness, DIN 53 157). The results are set out in Table 1 (column 4).

TABLE 1
film formation and stoving paints

| | With isocyanate | With isocyanate | |
|---|---|---|---|
| | Pendulum | Alcohol | With malamine resin |
| | hardness*) | resistance**) | Pendulum hardness |
| B1 | 168 Seconds | >3 Hours | 149 Seconds |
| C1***) | Sticks | Testing not possible | 70 Seconds |
| C2***) | Sticks | Testing not possible | 85 Seconds |

*)The König pendulum hardness (as measured to DIN 53 157) is expressed in seconds.
**)Alcohol resistance (to DIN 68861) was determined with ethanol. The value “>3 hours” means that no adverse effect on the surface was observed after 3 hours. Since this signifies high resistance to alcohol for practical requirements, the test was terminated at that point and the extent to which the value exceeded 3 hours was not determined.
***)Compounds C1 and C2 on which the comparison tests were based (see above) are polyester polyurethanes according to EP-B-669 352 cited at the beginning.

It is clear from Table 1 that Example 1 according to the invention is clearly superior to the Comparison Examples both in regard to film formation with isocyanate and in regard to the stoving paints.

1. Aqueous dispersions of polyurethanes with an acid value of 5 to 60 mg KOH/g polyurethane solids, a hydroxyl group content of 0.25 to 6.5% by weight and a urethane group content (expressed as —NH—CO—O—) of 2 to 25% by weight, based on polyurethane solids, characterized in that the polyurethanes are reaction products—optionally at least partly neutralized with bases—of
a) 10 to 80% by weight of at least one dimer diol,
b) 10 to 80% by weight of at least one dimer diol carbonate and/or dimer diol ether,
c) 1 to 10% by weight of at least one acid component consisting of i) hydroxycarboxylic acids, ii) aminocarboxylic acids, iii) aminosulfonic acid and iv) hydroxysulfonic acids,
d) 0 to 20% by weight of a low molecular weight component consisting of compounds containing at least two hydroxyl and/or amino groups with a molecular weight in the range from 60 to 300,
e) 0 to 20% by weight of at least one hydrophilic mono- or polyhydric alcohol containing ethylene oxide units with a molecular weight in the range from 350 to 3,000,
f) 5 to 40% by weight of an isocyanate component,
the percentages mentioned adding up to 100.

2. The use of the aqueous dispersions claimed in claim 1 for the production of water-containing coating compositions based on dispersions in water of binders and crosslinker resins selected from the group consisting of amino resins, optionally hydrophilicized blocked polyisocyanates and optionally hydrophilicized polyisocyanates containing free isocyanate groups.

3. A water-containing coating composition optionally containing typical auxiliaries and additives, characterized in that it contains as binder a combination of
A) a polyol component with
B) a crosslinker resin selected from the group consisting of melamine resins, optionally hydrophilicized blocked polyisocyanates and optionally hydrophilicized polyisocyanates containing free isocyanate groups,
25 to 100% by weight of polyol component A) consisting of a hydroxyl-group-containing polyurethane of the type present as a dispersion in water as claimed in claim 1 and 0 to 75% by weight of other binders different from these polyurethanes.
